(19) United States
(12) Patent Application Publication
(10) Pub. No.: US 2007/0060137 A1
(43) Pub. Date: Mar. 15, 2007

(54) Methods, systems, and computer program products for call/message routing based on determined subscriber activity

(75) Inventors: Stanley K. Yeatts, Atlanta, GA (US); Gregory Newton, Dunwoody, GA (US); John Ruckart, Atlanta, GA (US)

Correspondence Address: MYERS BIGEL SIBLEY & SAJOVEC, P.A., P.O. BOX 37428, RALEIGH, NC, 27627, US

(73) Assignee: BellSouth Intellectual Property Corporation

(21) Appl. No.: 11/322,636

(22) Filed: Dec. 30, 2005

Related U.S. Application Data
(60) Provisional application No. 60/717,213, filed on Sep. 15, 2005.

(51) Int. Cl. H04Q 7/20

(52) U.S. Cl. 455/445

(57) ABSTRACT

A method of providing communications can include selectively routing subscriber calls/messages to among a plurality of associated subscriber devices based on determined subscriber activity. Related systems and computer program product are also disclosed.

### CROSS REFERENCE RELATED APPLICATION

This Application is related to and claims the priority of U.S. Provisional Patent Application Ser. No. 60/717,213, filed Sep. 15, 2005, entitled Systems and Methods for Call Processing and Message Routing Based on User Characteristics, the disclosure of which is hereby incorporated herein by reference.

### FIELD OF THE INVENTION

The present invention generally relates to the field of electronic communications.

### BACKGROUND

A wide variety of means exist for communication between users. For example, a user may be contacted via a home phone, work phone, mobile phone etc. In addition, users may also communicate using devices such as PC's, PDA's, pagers, etc. using, for example, email and instant messaging.

Managing such a wide variety of communications for these devices can be difficult, such as, when a user changes location. For example, while traveling, it may only be possible to reach a user via the user's mobile phone. However, the user may best be reached by email while at work. Also, the user may wish to implement various rules for receiving and controlling communications. For example, to be reached at home, the user may want the home phone to ring three times before forwarding the call to a mobile phone. As another example, the user may wish to be paged each time an email is received from a particular person while away from the office, all of which may be unknown to those who wish to contact the user.

Another approach to improving the likelihood that a user may be reached is the development of Find-Me/Follow-Me profiles. In a Find-Me/Follow-Me profile, a call to a user is routed according to a predetermined sequence of enumerated telephone numbers specified by the user. For example, a user may set up a Find-Me/Follow-Me profile that routes calls first to the user's cell phone, then to the user's home phone, next to the user's work phone, and lastly to the user's voice mail. In some Find-Me/Follow-Me profiles, the call routing is conducted in the predetermined order regardless of the likelihood that the user will be reached at any of the numbers.

### SUMMARY

Embodiments according to the invention can provide methods, systems, and computer program products for call/message routing based on determined subscriber activity. Pursuant to these embodiments, a method of providing communications can include selectively routing subscriber calls/messages to among a plurality of associated subscriber devices based on determined subscriber activity.

In some embodiments according to the invention, the method further includes receiving location information associated with the subscriber as a subscriber location changes. A device register is updated indicating a subscriber device that the calls/messages are to be routed to improve a likelihood that the calls/messages will reach the subscriber as the subscriber location changes to provide determined location information. A call/message is received to be routed to the subscriber and the call/message is routed to the subscriber device indicated in the device register.

In some embodiments according to the invention, selectively routing subscriber calls/messages to among a plurality of associated subscriber devices based on determined subscriber activity includes routing the calls/messages to a selected one of the plurality of associated subscriber devices based any combination of location data associated with the subscriber, status information for at least one of the plurality of associated subscriber devices, calendar information for the subscriber and an active profile for the subscriber.

In some embodiments according to the invention, selectively routing subscriber calls/messages to among a plurality of associated subscriber devices based on determined subscriber activity includes changing an ordered sequence of subscriber devices in a find-me/follow-me profile used for call and/or message routing based on the combination.

In some embodiments according to the invention, selectively routing subscriber calls/messages to among a plurality of associated subscriber devices based on determined subscriber activity includes routing the calls/messages to a selected one of the plurality of associated subscriber devices based on determined location data associated with the subscriber.

In some embodiments according to the invention, selectively routing subscriber calls/messages to among a plurality of associated subscriber devices based on determined subscriber activity includes routing the calls/messages to a selected one of the plurality of associated subscriber devices based on determined status information for at least one of the plurality of associated subscriber devices.

In some embodiments according to the invention, selectively routing subscriber calls/messages to among a plurality of associated subscriber devices based on determined subscriber activity includes routing the calls/messages to a selected one of the plurality of associated subscriber devices based on determined calendar information for the subscriber.

In some embodiments according to the invention, selectively routing subscriber calls/messages to among a plurality of associated subscriber devices based on determined subscriber activity includes routing the calls/messages to a selected one of the plurality of associated subscriber devices based on a determined active profile for the subscriber.

In some embodiments according to the invention, a system configured to route calls/messages to a subscriber includes a call routing indicator configured to indicate selective routing of subscriber calls/messages to among a plurality of associated subscriber devices based on determined subscriber activity and to provide a call/message routing indication of a selected associated subscriber device to a call/message routing system.

In some embodiments according to the invention, a computer program product configured to provide information to route calls/messages to a subscriber includes a computer readable medium having computer readable program code embodied therein, the computer readable program product includes computer readable program code configured to selectively route subscriber calls/messages to among a plurality of associated subscriber devices based on determined subscriber activity.

### BRIEF DESCRIPTION OF THE DRAWINGS

FIG. 1 is a schematic illustration of a call/message routing system that selectively routes calls/messages to subscriber devices based on determined subscriber activity according to some embodiments of the invention.

FIG. 2 is a schematic illustration of a call/message routing indicator that provides routing information to a call/message routing system according to some embodiments of the invention.

FIG. 3 is a schematic illustration of a call/message routing indicator that provides call routing information to a call/message routing system based on determined location information for a subscriber according to some embodiments of the invention.

FIG. 4 is a schematic illustration of a call/message indicator that provides call routing information to a call/message routing system based on subscriber device status according to some embodiments of the invention.

FIG. 5 is a schematic illustration of a call/message indicator that provides call routing information to a call/message routing system based on calendar information according to some embodiments of the invention.

FIG. 6 is a schematic illustration of a call/message indicator that provides routing information to a call/message routing system based on a subscriber profile according to some embodiments of the invention.

FIGS. 7A-7E are schematic illustrations of changes made to a Find-Me/Follow-Me profile based on determined subscriber activity according to some embodiments of the invention.

FIG. 8 is a block diagram of a call/message indicator that provides call/message routing information to a call/message routing system according to some embodiments of the invention.

### DESCRIPTION OF THE EMBODIMENTS ACCORDING TO THE INVENTION

The present invention now is described more fully hereinafter with reference to the accompanying figures, in which embodiments of the invention are shown. This invention may, however, be embodied in many alternate forms and should not be construed as limited to the embodiments set forth herein. Like numbers refer to like elements throughout the description of the figures.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein the term “and/or” includes any and all combinations of one or more of the associated listed items.

It will be understood that, when an element is referred to as being “coupled” to another element, it can be directly coupled to the other element or intervening elements may be present. In contrast, when an element is referred to as being “directly coupled” to another element, there are no intervening elements present.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense expressly so defined herein.

The present invention is described below with reference to diagrams (such as schematic illustrations) and/or operational illustrations of methods, devices, and computer program products according to embodiments of the invention. It is to be understood that the functions/acts noted in the figures may occur out of the order noted in the operational illustrations. For example, two elements shown in succession may in fact be executed substantially concurrently or the elements may sometimes be executed in the reverse order, depending upon the functionality/acts involved.

The present invention may be embodied in hardware and/or in software (including firmware, resident software, micro-code, etc.). Furthermore, the present invention may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM).

Computer program code or “code” for carrying out operations according to the present invention may be written in an object oriented programming language such as JAVA®, Smalltalk or C++, JavaScript, Visual Basic, TSQL, Perl, or in various other programming languages. Software embodiments of the present invention do not depend on implementation with a particular programming language. Portions of the code may execute entirely on one or more systems utilized by an intermediary server.

The computer program code may be provided to a processor of a general purpose computer, special purpose computer, or other programmable data processing apparatus as instructions to produce a machine, such that the instructions, which execute via the processor of the computer or other programmable data processing apparatus, create means for implementing the functions specified in the illustrations.

The computer code may be stored in a computer-readable memory that can direct a computer or other programmable data processing apparatus to function in a particular manner, such that the instructions stored in the computer-readable memory produce an article of manufacture including instruction means which implement the function specified in the illustrations.

It will be understood that at least a portion of the communications between the call/message indicator and the call/message routing system and between the call/message routing system and the networks used to route the calls.messages described herein can be provided according to Session Initiation Protocol (SIP), which is described in more detail in, for example, “Internet Communications Using SIP,” by Henry Sinnreich, ISBN: 0-471-41399-2. Internet Protocol communications are generally described in, for example, “TCP/IP Protocol Suite,” by Behrouz A Forouzan, ISBN: 0-07-119962-4. Moreover, techniques for the creation and operation of virtual communities, is described in, for example, “Design for Community: The Art of Connecting Real People in Virtual Places,” by Derek M. Powazek, ISBN: 0-7357-1075-9. The content these references is incorporated herein by reference.

The communications used for messages may be provided using an Internet Protocol (IP) Multimedia Subsystem (IMS). IMS can utilize a packet switched domain (such as the Internet) to transport multimedia signaling and bearer traffic. The message forwarding may be provided, for example, via a Universal Mobile Telecommunication System (UMTS) to access multimedia services of IMS. IP Multimedia Systems are discussed in each of the following: (1) 3GPP TS 22.228 entitled “Service Requirements for the IP Multimedia Core Network Subsystems”; (2) 3GPP TS 23.228 entitled “IP Multimedia Subsystems”; and (3) 3GPP TR 22.941 entitled “IP Based Multimedia Services Framework.” The subject matter of each of these references is hereby incorporated by reference.

It will be understood that messages can be provided via a TCP/IP Session Initiation Protocol (SIP) message, a SS7 (Signaling System 7) message, a common channel SS7 message, an in-band signaling message, and/or a Short Message Service (SMS) message, an Enhanced Message Service (EMS) message, a Multimedia Message Service (MMS) message, and/or Smartmessaging™ message. As is known to those skilled in the art, SMS and EMS messages can be transmitted on digital networks, such as GSM networks, allowing relatively small text messages (for example, 160 characters in size) to be sent and received via a network operator's message center to the user device, or via the Internet, using a so-called SMS (or EMS) “gateway.”

As described herein in greater detail, selective call/message routing can be provided among a plurality of associated subscriber devices based on determined subscriber activity. The determined subscriber activity can include, for example, a determined location of the subscriber (implied from the reported location of a subscriber device associated with the subscriber), a calendar application including calendar information associated with the subscriber, a profile activated by the subscriber which may indicate subscriber status, and/or subscriber device status that can indicate the status of devices associated with the subscriber.

In operation, the determined subscriber activity is provided to a call/message routing indicator which can indicate which of the devices associated with the subscriber is the device to which calls/messages may be routed to improve the likelihood that the call/message reaches the subscriber. It will be understood that in some embodiments according to the invention, a single type of determined subscriber activity (such as a subscriber location) can be used to provide an indication of the device to which calls/messages are to be routed. In other embodiments according to the invention, a number of determined subscriber activities may be combined when provided to the call/message routing indicator whereupon the call/message routing indicator may combine and weight the respective determined subscriber activities to provide the indication of which subscriber device will be used for routing.

In some embodiments according to the invention, a Find-Me/Follow-Me profile can be used in conjunction with the determined subscriber activity such that the call/message routing indicator may change the order in which the subscriber devices are specified in the Find-Me/Follow-Me profile. For example, the determined subscriber activity may indicate that the subscriber's cell phone is switched off and, therefore, the cell phone may be eliminated from the Find-Me/Follow-Me profile. Upon receiving a call, the call routing may occur according to the modified Find-Me/Follow-Me profile so that no attempt is made to route the call to the cell phone as the determined subscriber activity has indicated that the cell phone is turned off and therefore, it is unlikely that the call/message will reach the subscriber via the cell phone.

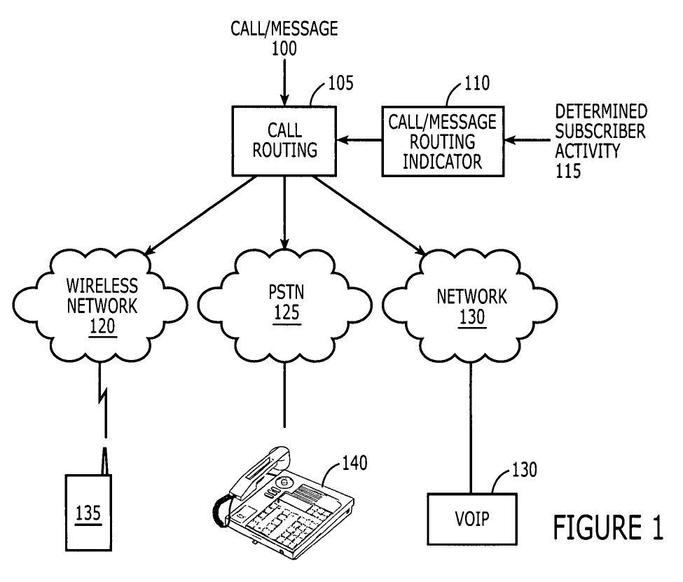

FIG. 1 is a schematic illustration of a call/message routing system 105 that receive calls/messages 100 directed to a subscriber of the call/message routing system 105. According to FIG. 1, a call/message routing indicator 110 provides a message to the call/message routing system 105 which indicates that the call/message 100 is to be routed to a particular subscriber device. The call/message routing indicator 110 can provide the message including the indication of the call routing information based on determined subscriber activity 115. Accordingly, in some embodiments according to the invention, the call/message routing indicator 110 can provide for selective routing of subscriber calls/messages among a plurality of associated subscriber devices based on the determined subscriber activity 115.

In operation, the call/message routing system 105 receives the message from the call/message routing indicator 110, and routes the call/message 100 to the network that provides service to the indicated subscriber device included in the message. In particular, the call/message routing system 105 can route the call/message 100 to a wireless network 120 which services a cellular telephone 135 (i.e., cell phone) or a public switched telephone network (PSTN) 125 which services a POTS telephone 140, or to a network 130 (such as the Internet) that provides service to a Voice over Internet Protocol (VoIP) phone 145. It will be understood that other networks can also be accessed by the call/message routing system 105 to provide call routing to a subscriber device among the plurality of associated subscriber devices that can be indicated by the message transmitted by the call/message routine indicator 110.

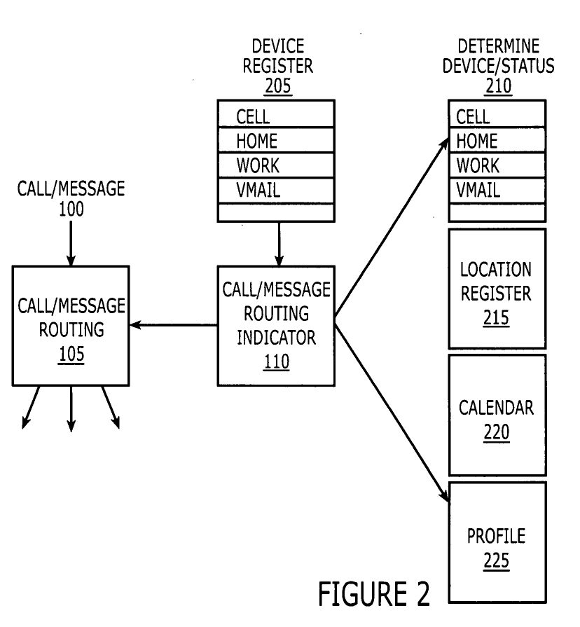

FIG. 2 is a schematic illustration of the call/message routing system 105 operatively coupled to the call/message routing indicator 110 being provided with a variety of determined subscriber activity according to some embodiments of the invention. As shown in FIG. 2, the call/message routing indicator 110 is operatively coupled to a device register 205 that includes a listing of known devices associated with the subscriber. For example, as shown in FIG. 2, the device register 205 includes a cell phone, a work phone, a home phone, and a pager. In operation, the call/message routing indicator 110 can select a subscriber device listed in the device register 205 which can be provided to the call/message routing system 105 via the message transmitted by the call/message routing indicator 110.

It will be further understood that the device register 205 may be available directly to the call/message routing system 105 without the intervention of the call/message routing indicator 110. In such embodiments according to the invention, the message transmitted by the call/message routing indicator 110 may indirectly reference the subscriber device to which calls/messages are to be routed whereupon the call/message routing system 105 accesses the device register 205 for the specific information needed for routing of calls/messages to the indicated subscriber device.

As further shown in FIG. 2, a variety of determined subscriber activity can be provided to the call/message routing indicator 110 upon which the subscriber device included in the device register 205 can be selected for routing. In particular, the determined subscriber activity can be based on determined device status included in a device status register 210 associated with any or all of the subscriber devices. For example, device status can be provided for the subscriber's cell phone, home phone, work phone, and/or pager. In some embodiments according to the invention, the determined device status can specify whether the associated device is on or off, what type of ringer is enabled, and other indications of how the device is presently configured by the subscriber.

The determined subscriber activity can also include a determined location included in a location register 215 that can be provided as the location of the subscriber changes, which can be reported via a variety of means as described herein in greater detail. The determined subscriber activity can also include calendar information reported by a calendar 220 that includes schedule, appointment, activities, meetings, and other calendar information associated with the subscriber. The determined subscriber activity can also include a profile 225, which can specify the subscriber's status. In some embodiments according to the invention, the subscriber status can include a “do not disturb” (DND) status, an originator based DND status, and/or a priority based DND status.

In operation, any or all of the determined subscriber activity described above can be reported to the call/message routing indicator 110. The call/message routing indicator 110 determines which of the subscriber devices included in the device register 205 is to be selected for routing based thereon. The call/message routing indicator 110 transmits a message to the call/message routing system 105 including an indication of which of the subscriber devices is to be used for routing of the call/message 100 received by the call/message routing system 105.

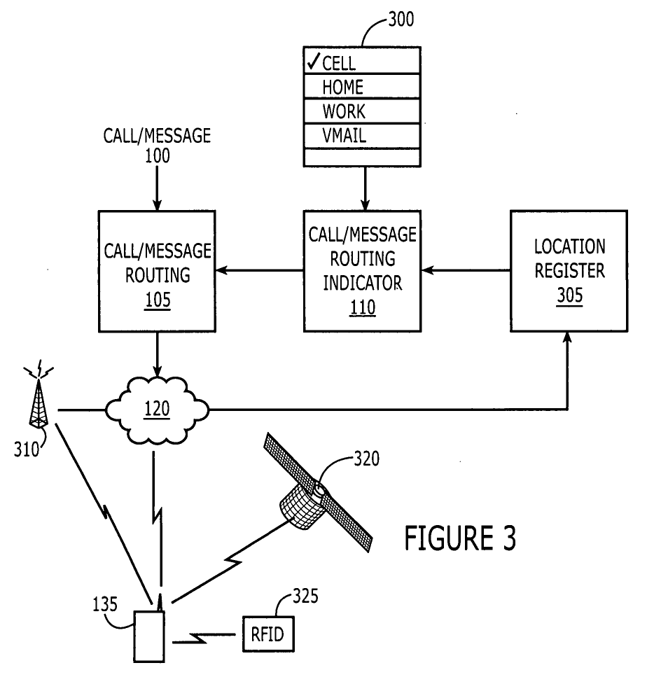

FIG. 3 is a schematic illustration of a call/message indicator 110 that provides the indication of a subscriber device for selective routing of subscriber calls based on determined subscriber activity from a location register 305 according to some embodiments of the invention. In particular, the location register 305 can provide location information associated with a subscriber using a variety of means, such as the cell phone 135 including a GPS receiver in communication with a GPS satellite 320 that provides GPS data to the cell phone 135. The cell phone 135, in turn, can provide the GPS data or the location data to the location register 305 via a network 120 that includes a wireless network that provides service to the cell phone 135.

It will be understood that the cell phone may determine a location using the GPS data with any available GPS or assisted GPS based location approach. Some approaches are commonly referred to as assisted-GPS, which is defined, for example, in specification numbers 3GPP TS 04.31, 3GPP TS 03.71 and 3GPP TS 04.35. Assisted-GPS approaches are also discussed, for example, in U.S. Pat. Nos. 4,445,118, and 5,418,538, and 5,663,734, and 5,663,735, and 6,433,735, and in published US Patent Application No. US 2003/0011511 A1, the disclosures of which are hereby incorporated herein by reference.

In other embodiments according to the invention, the location of the subscriber can be provided by receiving RFID information from an RFID transmitter 325 that is in communication with, for example, the cell phone 135 that includes an RFID receiver. The cell phone 135 can transmit, for example, a unique tag received from the RFID transmitter 325 to the location register 305. The location register 305 may have access to location information that associates the RFID tag transmitted by the RFID transmitter 325 with known locations so that the location register 305 can provide determined subscriber activity to the call/message indicator 110.

It will be appreciated by those skilled in the art that Radio Frequency Identification (RFID) refers to the use of low-cost “tags” embedded in or attached to items and store “bar code” type information, as well as more detailed information about the items. The tags are generally small labels, or the like, with a miniature embedded antenna. A tag reader (sometimes referred to herein as an RFID receiver) interrogates the tag by transmitting an RFID signal, which energizes the embedded antenna to provide power for the tag to transmit a responsive RFID signal to the reader.

In other embodiments according to the invention, location information can be provided from the wireless network 120 that provides service to the cell phone 135. For example, the base station 310 shown in FIG. 3 can provide location data to the cell phone 135, such as the known locations of the base stations 310. The cell phone 135 can use the locations of the base stations to approximate a location, which is transmitted to location register 305.

It will be understood that although FIG. 3 illustrates location information being provided by the cell phone 135, the location information may be provided by any device that is capable of receiving or determining location information from any of the systems described above as well as any other system known to those skilled in the art that is capable of providing such information to the cell phone 135.

Still referring to FIG. 3, the cell phone 135 reports location information to the location register 305 which is, in turn, provided to call/message indicator 110. The call/message indicator 110 determines that call/messages 100 should be routed to the cell phone 135 to improve the likelihood that the calls/messages will be received by the subscriber based on, for example, observing that the subscriber is away from the other registered devices.

It will further be understood that the device that determines and/or reports the location information may or may not be the device to which the calls/messages are routed by the call/message routing system 105. For example, in some embodiments according to the invention, the radio receiver portion of the cell phone 135 may be switched to “off” (i.e., in safe mode) such that calls to the cell phone 135 may not be possible. However, the cell phone 135 may still be capable of reporting location information to the location register 305 whereupon the call/message indicator 110 can select another subscriber device (such as the work phone) for routing of calls/messages to the subscriber.

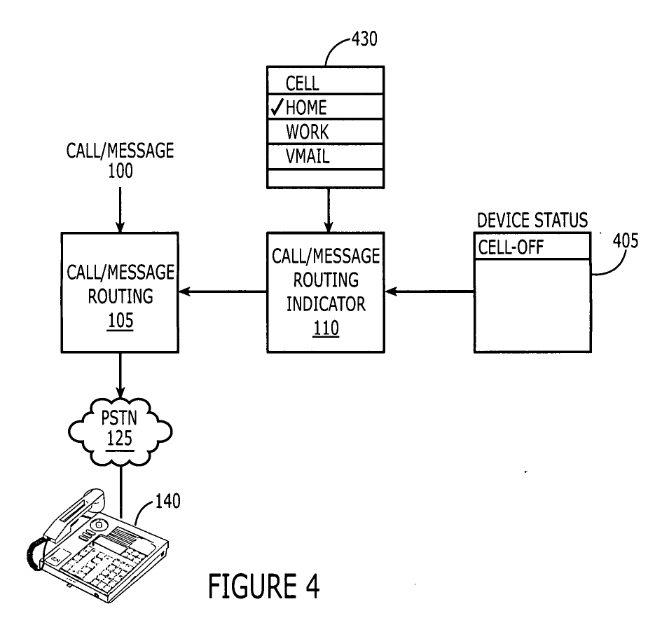

FIG. 4 is a schematic illustration of the call/message indicator 110 providing a message to the call/message routing system 105 indicating a subscriber device for selective routing of calls/messages based on determined subscriber activity including device status information 405. According to FIG. 4, device status information associated with the cell phone indicates that the cell phone is currently “off.” Accordingly, the determined subscriber activity, including that the cell phone status is “off,” is reported to the call/message indicator 110. The call/message indicator 110 selects the home phone as the subscriber device to which calls/messages should be routed to improve the likelihood that the calls/messages will be received by the subscriber. The call/message indicator 110 provides the message to the call/message routing system 105 including the indication that the home phone is to be used for selective routing. When the call/message 100 is received by the call/message routing system 105, the call/message is routed to the home phone 140 via the PSTN 125.

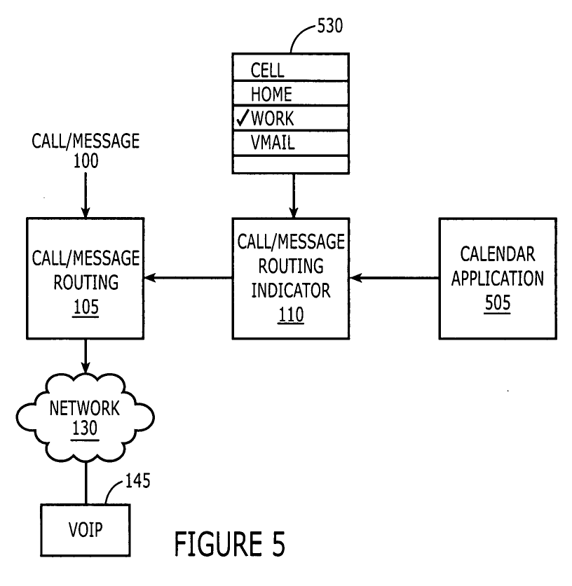

FIG. 5 is a schematic illustration of the call/message indicator 110 that receives determined subscriber activity from a calendar application 505 and forwards a message to the call/message routing system 105 for subsequent routing of calls/messages to the subscriber devices in some embodiments according to the invention. As shown in FIG. 5, calendar information for the subscriber is provided to the call/message indicator 110. The call/message indicator 110 determines, based on the calendar information forwarded, that the work phone is the subscriber device to which calls/messages may be routed to improve the likelihood that the subscriber actually receives the calls/messages. The message provided by the call/message indicator 110 therefore includes an indication that the work phone is to be used for selective routing of subscriber calls so that the calls/messages are routed to the VoIP phone 145 via the network 130.

In some embodiments according to the invention, the calendar information for the subscriber can include meetings or appointments of a business or personal nature which can indicate (directly or indirectly) the subscriber's likely location and activities thereat. For example, the calendar information may indicate that the subscriber is scheduled to be in a meeting for the next several hours. Accordingly, the call/message indicator 110 may select a subscriber device which is more appropriate for a meeting, such as the pager. The calendar information for the subscriber can also indicate that the subscriber is on a business trip and therefore likely may not be reached at the home or work phone and may more likely be reached via the cell phone or pager. The calendar information for the subscriber may also indicate that the subscriber is on vacation and, therefore, the call/message indicator 110 may provide a message to the call/message routing system 105 indicating that the calls/messages 100 should be routed directly to the subscriber's voice mail.

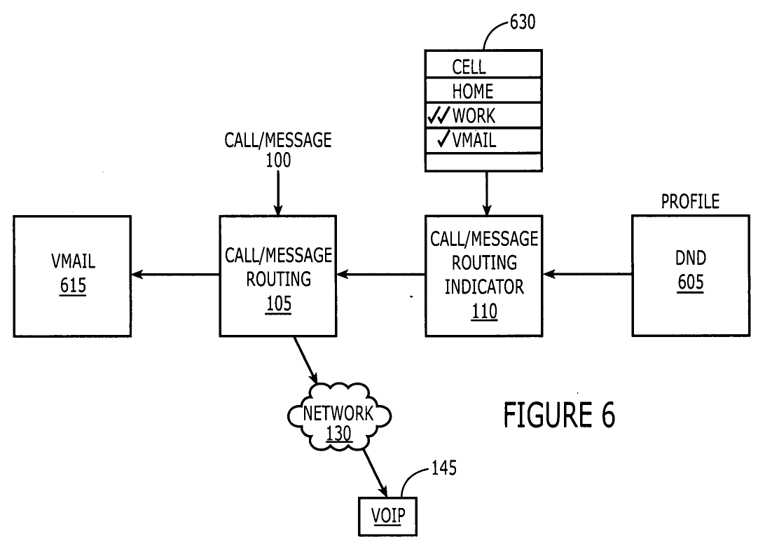

FIG. 6 is a schematic illustration of the call/message indicator 110 provided with determined subscriber activity from a subscriber profile 605 used to select a subscriber device from the device register 630 indicated in the message to the call/message routing system 105 according to some embodiments of the invention. According to FIG. 6, the subscriber profile 605 provides determined subscriber activity indicating that the subscriber does not wish to be disturbed at this time (i.e., DND). Accordingly, the call/message indicator 110 can select voice mail among subscriber's devices included in the subscriber device register 630 and forward a message to the call/message routing system 105 indicating that calls/messages should be routed directly to the subscriber's voice mail 615.

In other embodiments according to the invention, the subscriber profile 605 may indicate a originator based DND status, wherein the subscriber does not wish to be disturbed unless a call/message is originated from a particular person(s). The message forwarded by the call/message indicator 110 may include a conditional indication that calls/messages originated by anyone other than those specified should be routed directly to the voice mail 615, whereas if the call/message is from the specified originator(s), the call/message 100 is routed to a secondary device included in the device register 630 (in this example, the work phone 145 via the network 130 designated by the double check marks in FIG. 6).

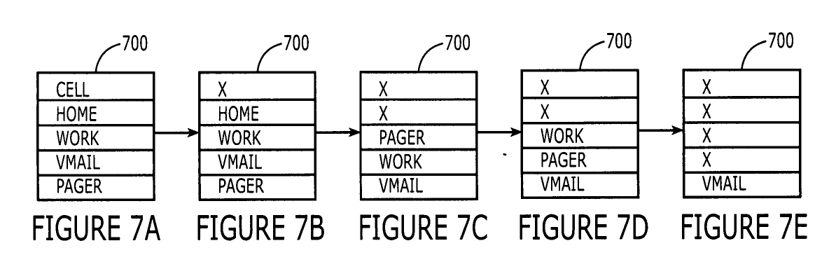

FIGS. 7A-E are schematic illustrations of a Find-Me/Follow-Me profile 700 including an ordered list of subscriber devices to which messages will be sequentially routed for the subscriber, the order of which may be changed based on determined subscriber activity in some embodiments according to the invention. According to FIG. 7A, the Find-Me/Follow-Me profile 700 specifies that calls/messages are to be forwarded to subscriber devices in the following order: first to the cell phone, second to the home phone, third to the work phone, fourth to the voice mail, and fifth to a pager. In some embodiments according to the invention, as determined subscriber activity is reported to the call/message indicator 110, the order of the subscriber devices listed in the Find-Me/Follow-Me profile 700 may be changed so as to improve the likelihood that the calls/messages will be received by the subscriber earlier in the sequence.

According to FIG. 7B, the subscriber switches off the cell phone listed in the Find-Me/Follow-Me profile 700 resulting in the cell phone being removed from the profile so that any incoming call/message is routed first to the home phone rather than to the cell phone. According to FIG. 7C, calendar information indicating that the subscriber is now scheduled to be in a meeting at work is reported as the determined subscriber activity to the call/message indicator, whereupon the call/message indicator updates the Find-Me/Follow-Me profile 700 to remove the home phone from the profile so that any subsequent calls/messages are forwarded to the pager first rather than to the cell phone or the home phone.

According to FIG. 7D, the subscriber's location at the office is reported as determined subscriber activity to the call/message routing indicator whereupon the Find-Me/Follow-Me Profile 700 is updated so that the work phone is now listed as the first subscriber device to which calls/messages should be routed to increase the likelihood that the call/message will reach the subscriber at work earlier than otherwise. Accordingly, the pager is moved to later in the sequence (i.e., after the work phone). According to FIG. 7E, the subscriber activates a DND profile while at the office which is reported as determined subscriber activity to the call/message indicator whereupon the Find-Me/Follow-Me profile 700 is updated to remove the work phone and pager from the profile so that any calls/messages being received while the DND profile is active, are forwarded directly to voice mail so as not to disturb the subscriber.

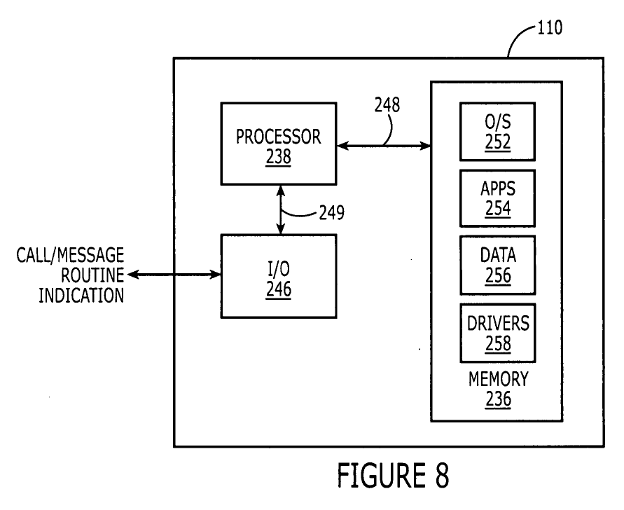

FIG. 8 is a block diagram of an exemplary call/message routing indicator 110 configured to update a message routing profile in some embodiments according to the invention. As illustrated, the call/message routing indicator 110 includes a processor 238, a memory 236 and input/output (I/O) circuits 246. The profile manager 110 may be incorporated in, for example, a general purpose computer, server, or the like. The processor 238 communicates with the memory 236 via an address/data bus 248 and communicates with the input/output circuits 246 via an address/data bus 249.

The call/message routing indicator 110 provides the message indicating the selective call/message routing through the input/output circuits 246 using, for example, an Internet Protocol (IP) connection to receive messages from the communications device 100.

The components in the profile manager 110 may be known components such as those used in many data processing systems, which may be configured to operate as described herein. In particular, the processor 238 can be any commercially available or custom microprocessor, microcontroller, digital signal processor or the like. The memory 236 may include any memory devices containing the software and data used to implement the functionality circuits or modules used in accordance with embodiments of the present invention. The memory 236 can include, but is not limited to, the following types of devices: ROM, PROM, EPROM, EEPROM, flash memory, SRAM, DRAM and magnetic disk.

As further illustrated in FIG. 8, the memory 236 may include several categories of software to provide operation of the call/message routing indicator 110: an operating system 252; application programs 254 including the software to provide the operations of the call/message routing indicator described herein, input/output device drivers 258; and data 256.

The data 256 represents the static and dynamic data used by the application programs 254, the operating system 252, and the input/output device drivers 258, that may reside in the memory 236. The data 56 can include the different profiles to be used and the profile parameters included therein, RFID tags associated with know locations, etc. as described herein.

As will be appreciated by those of skill in the art, the operating system 252 may be any operating system suitable for use with a data processing system, such as OS/2, AIX or zOS from International Business Machines Corporation, Armonk, N.Y., Windows 95, Windows98, Windows2000 or WindowsXP from Microsoft Corporation, Redmond, Wash., Unix or Linux. The input/output device drivers 258 typically include software routines accessed through the operating system 252 by the application programs 254 to communicate with devices such as the input/output circuits 246 and the memory 236.

As described herein, selective call/message routing can be provided among a plurality of associated subscriber devices based on determined subscriber activity. The determined subscriber activity can include, for example, a determined location of the subscriber (implied from the reported location of a subscriber device associated with the subscriber), a calendar application including calendar information associated with the subscriber, a profile activated by the subscriber which may indicate subscriber status, and/or subscriber device status that can indicate the status of devices associated with the subscriber.

In operation, the determined subscriber activity is provided to a call/message routing indicator which can indicate which of the devices associated with the subscriber is the device to which calls/messages may be routed to improve the likelihood that the call/message reaches the subscriber. It will be understood that in some embodiments according to the invention, a single type of determined subscriber activity (such as a subscriber location) can be used to provide an indication of the device to which calls/messages are to be routed. In other embodiments according to the invention, a number of determined subscriber activities may be combined when provided to the call/message routing indicator whereupon the call/message routing indicator may combine and weight the respective determined subscriber activities to provide the indication of which subscriber device will be used for routing.

In the drawings and specification, there have been disclosed embodiments of the invention and, although specific terms are employed, they are used in a generic and descriptive sense only and not for purposes of limitation, the scope of the invention being set forth in the following claims.

What is claimed:

1. A method of providing communications comprising:
selectively routing subscriber calls/messages to among a plurality of associated subscriber devices based on determined subscriber activity.

2. A method according to claim 1 further comprising:
receiving location information associated with the subscriber as a subscriber location changes;
updating a device register indicating a subscriber device that the calls/messages are to be routed to improve a likelihood that the calls/messages will reach the subscriber as the subscriber location changes to provide determined location information;
receiving a call or message to be routed to the subscriber; and
routing the call or message to the subscriber device indicated in the device register.

3. A method according to claim 1 wherein selectively routing subscriber calls/messages to among a plurality of associated subscriber devices based on determined subscriber activity comprises routing the calls/messages to a selected one of the plurality of associated subscriber devices based any combination of location data associated with the subscriber, status information for at least one of the plurality of associated subscriber devices, calendar information for the subscriber and an active profile for the subscriber.

4. A method according to claim 3 wherein selectively routing subscriber calls/messages to among a plurality of associated subscriber devices based on determined subscriber activity comprises changing an ordered sequence of subscriber devices in a find-me/follow-me profile used for call and/or message routing based on the combination.

5. A method according to claim 1 wherein selectively routing subscriber calls/messages to among a plurality of associated subscriber devices based on determined subscriber activity comprises routing the calls/messages to a selected one of the plurality of associated subscriber devices based on determined location data associated with the subscriber.

6. A method according to claim 1 wherein selectively routing subscriber calls/messages to among a plurality of associated subscriber devices based on determined subscriber activity comprises routing the calls/messages to a selected one of the plurality of associated subscriber devices based on determined status information for at least one of the plurality of associated subscriber devices.

7. A method according to claim 1 wherein selectively routing subscriber calls/messages to among a plurality of associated subscriber devices based on determined subscriber activity comprises routing the calls/messages to a selected one of the plurality of associated subscriber devices based on determined calendar information for the subscriber.

8. A method according to claim 1 wherein selectively routing subscriber calls/messages to among a plurality of associated subscriber devices based on determined subscriber activity comprises routing the calls/messages to a selected one of the plurality of associated subscriber devices based on a determined active profile for the subscriber.

9. A system configured to route calls/messages to a subscriber, the system comprising:
a call routing indicator configured to indicate selective routing of subscriber calls/messages to among a plurality of associated subscriber devices based on determined subscriber activity and to provide a call/message routing indication of a selected associated subscriber device to a call/message routing system.

10. A system according to claim 9 further comprising:
a location information register, operatively coupled to the call routing indicator, including location data associated with the subscriber as the subscriber location changes;
a device register, operatively coupled to the call routing indicator, indicating a subscriber device that the calls/messages are to be routed to improve a likelihood that the calls/messages will reach the subscriber as the subscriber location changes to provide determined location information;
a subscriber profile, operatively coupled to the call routing indicator, configured to indicate how calls are to be routed based on subscriber preferences;
a device status register, operatively coupled to the call routing indicator, indicating a status for registered subscriber devices; and
a subscriber calendar application, operatively coupled to the call routing indicator, indicating calendar information for the subscriber.

11. A system according to claim 9 further comprising:
a find-me/follow-me profile, operatively coupled to the call routing indicator, wherein subscriber devices, in the find-me/follow-me profile, are in an ordered sequence according to which calls/messages are to be routed, the ordered list being configured to be dynamically re-ordered based on a combination of inputs from the subscriber profile, the device status register, the subscriber calendar application, and/or the location register.

12. A system according to claim 10 wherein the call indicator is configured to indicate selective routing to one of the plurality of associated subscriber devices based any combination of the location data, the status for registered subscriber devices, calendar information for the subscriber, and the subscriber profile.

13. A computer program product configured to provide information to route calls/messages to a subscriber comprising a computer readable medium having computer readable program code embodied therein, the computer readable program product comprising:
computer readable program code configured to selectively route subscriber calls/messages to among a plurality of associated subscriber devices based on determined subscriber activity.

14. A computer program product according to claim 13 further comprising:
computer readable program code configured to receive location information associated with the subscriber as a subscriber location changes;
computer readable program code configured to update a device register indicating a subscriber device that the calls/messages are to be routed to improve a likelihood that the calls/messages will reach the subscriber as the subscriber location changes to provide determined location information;
computer readable program code configured to receive a call or message to be routed to the subscriber; and
computer readable program code configured to route the call or message to the subscriber device indicated in the device register.

15. A computer program product according to claim 13 wherein the computer readable program code configured to selectively route subscriber calls/messages to among a plurality of associated subscriber devices based on determined subscriber activity comprises computer readable program code configured to route the calls/messages to a selected one of the plurality of associated subscriber devices based any combination of location data associated with the subscriber, status information for at least one of the plurality of associated subscriber devices, calendar information for the subscriber and an active profile for the subscriber.

16. A computer program product according to claim 15 wherein the computer readable program code configured to selectively route subscriber calls/messages to among a plurality of associated subscriber devices based on determined subscriber activity comprises computer readable program code configured to change an ordered sequence of subscriber devices in a find-me/follow-me profile used for call and/or message routing based on the combination.

17. A computer program product according to claim 13 wherein the computer readable program code configured to selectively route subscriber calls/messages to among a plurality of associated subscriber devices based on determined subscriber activity comprises computer readable program code configured to route the calls/messages to a selected one of the plurality of associated subscriber devices based on determined location data associated with the subscriber.

18. A computer program product according to claim 13 wherein the computer readable program code configured to selectively route subscriber calls/messages to among a plurality of associated subscriber devices based on determined subscriber activity comprises computer readable program code configured to route the calls/messages to a selected one of the plurality of associated subscriber devices based on determined status information for at least one of the plurality of associated subscriber devices.

19. A computer program product according to claim 13 wherein the computer readable program code configured to selectively route subscriber calls/messages to among a plurality of associated subscriber devices based on determined subscriber activity comprises computer readable program code configured to route the calls/messages to a selected one of the plurality of associated subscriber devices based on determined calendar information for the subscriber.

20. A computer program product according to claim 13 wherein the computer readable program code configured to selectively route subscriber calls/messages to among a plurality of associated subscriber devices based on determined subscriber activity comprises computer readable program code configured to route the calls/messages to a selected one of the plurality of associated subscriber devices based on a determined active profile for the subscriber.
